(19) United States
(12) Patent Application Publication
(10) Pub. No.: US 2026/0099358 A1
(43) Pub. Date: Apr. 9, 2026

(54) PERFORMANCE-BASED SCHEDULING FOR CONTAINER ORCHESTRATION PLATFORMS IN A HETEROGENEOUS ENVIRONMENT

(71) Applicant: DELL PRODUCTS L.P., Round Rock, TX (US)

(72) Inventors: Parmeshwr Prasad, Bangalore (IN); Sathiabama Ranganathan, Bangalore (IN)

(21) Appl. No.: 18/909,366

(22) Filed: Oct. 8, 2024

(51) Int. Cl. G06F 9/48

(52) U.S. Cl. CPC G06F 9/4881

(57) ABSTRACT

Performance-based container orchestration scheduling includes retrieving, via a control plane API server, performance capacity information for the nodes of a container-based orchestration cluster. Based on the performance capacity information, metrics are generated by a metrics generator for each of the nodes of the cluster, the metrics measuring performance capabilities of each node for running the one or more containers. The nodes are prioritized by a prioritizing module based on processing the metrics for each node. Based on the prioritizing, a best-suited node for running the one or more containers is identified. The performance capacity of the best-suited node in running the one or more containers is greater than the performance capacity of other of the nodes in running the one or more containers. The one or more containers are scheduled by an integrated scheduler of the control plane to run on the best-suited node.

### FIELD OF THE DISCLOSURE

The present disclosure generally relates to information handling systems, and more particularly relates to container-based orchestration implemented with one or more information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

Performance-based container orchestration scheduling includes retrieving, via a control plane API server, performance capacity information from a plurality of nodes within a container-based orchestration cluster. The retrieving is initiated in response to the creation of one or more containers. Based on the performance capacity information, metrics are generated by metrics generator for each the nodes of the cluster. The metrics generated measure the performance capacity of each of the nodes for running the one or more containers. The nodes are prioritized by a prioritizing module based on processing the metrics for each of the nodes. Based on the prioritizing, a best-suited node for running the one or more containers among the nodes is identified. The performance capacity of the best-suited node in running the one or more containers is greater than the performance capacity of other of the plurality of nodes in running the one or more containers. The one or more containers are scheduled by an integrated scheduler of the control plane to run on the best-suited node.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of elements of an example container orchestration platform according to an embodiment of the present disclosure;

FIG. 2 is a message-flow diagram an exchange of messages within a container orchestration platform according to an embodiment of the present disclosure;

FIG. 3 illustrates an example process of prioritizing memories of nodes forming a container orchestration cluster according to an embodiment of the present disclosure;

FIG. 4 illustrates an example process of scheduling a container within an orchestration platform according to an embodiment of the present disclosure;

FIG. 5 is a flow diagram of an example method of scheduling nodes of a container orchestration platform according to an embodiment of the present disclosure;

FIG. 6 is a flow diagram of an example method of assigning one or more containers to an orchestration platform node according to an embodiment of the present disclosure; and

FIG. 7 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

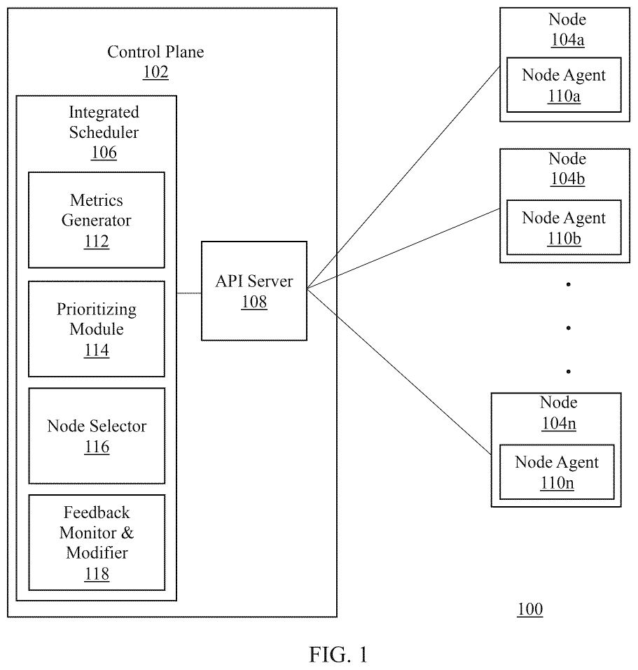

FIG. 1 illustrates an example cluster 100 of a container orchestration platform that is configured to automate the deployment, management, scaling, and networking of software applications and/or microservices. Illustratively, cluster 100 includes control plane 102 and a cluster comprising nodes 104a and 104b through 104n, where n is a positive integer. Control plane 102 is a collection of executable processes that may be distributed across multiple nodes or run on a dedicated master or control node. Nodes 104a-104n are physical or virtual machines. That is, each of nodes 104a-104n may be an information handling system or a virtual machine running on an information handling system.

For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Referring again to FIG. 1, although three nodes are explicitly shown, cluster 100 may include only one node or, more typically, may include many nodes. The open-source container orchestration platform Kubernetes, for example, as of recently supports clusters of up to 5,000 nodes. Operatively, control plane 102 manages nodes 104a-104n, which execute services (software) necessary to run containers on a cluster of nodes. A container is a lightweight, executable package that bundles an application or microservice with dependencies (e.g., code, runtime, libraries, system tools, settings) sufficient to utilize a node's operating system kernel in running the container. In addition to containers, Kubernetes is configured to create pods. A pod is a wrapper that groups one or more containers with shared specifications, storage, and networking for running the one or more containers on a node. Other container-based orchestration platforms (e.g., Docker Swarm, Apache Mesos) do not create pods, but nonetheless implement architectures whose container-scheduling features are similar to those of a Kubernetes control plane. Therefore, although aspects of the present disclosure are described primarily in the context of a Kubernetes orchestration platform, the embodiments described are broadly applicable to other orchestration platforms as well.

Referring still to FIG. 1, control plane 102 illustratively includes integrated scheduler 106 and API server 108. Integrated scheduler 106 is a control-plane process. The task of integrated scheduler 106 is to assign to one of nodes 104a-104n a newly created pod (or individual container in a non-Kubernetes context). In certain embodiments, integrated scheduler 106 is implemented with custom plugins that add capabilities and/or with extensions that add the features described herein to a Kubernetes scheduler, which is a component of the Kubernetes control plane.

By virtue of the added capabilities and features, integrated scheduler 106 implements processes that are distinct from those of a conventional scheduler. For example, as discussed in greater detail below, unlike conventional schedulers which tend to assign a container (or pod) to the first available node capable of running the container, integrated scheduler 106 is configured to seek the node that is most likely to optimize performance in running the container.

Operatively, integrated scheduler 106 assigns a pod (or individual container in the non-Kubernetes context) based on performance capacity information pertaining to nodes 104a-104n. The performance capacity information is obtained through processes executed by node agents 110a and 110b through 110n, which are instantiated on nodes 104a and 104b through 104n, respectively. In the Kubernetes context, nodes agents 110a-110n are primary node agents that are implemented as Kubelets. A Kubelet runs on each node of a cluster. Node agents 110a-110n, like Kubelets, do not communicate directly with integrated scheduler 106. Instead, node agents 110a-110n instantiated on nodes 104a-104n communicate indirectly with integrated scheduler 106 via API server 108.

Integrated scheduler 106 is tasked with detecting a newly created or unassigned pod and assigning it to one of nodes 104a-104n based on criteria that include the resource requirements of the container(s) wrapped in the pod. A node agent (e.g., Kubelet) instantiated on the node to which the pod is assigned interacts with container runtime(s) to start and manage the container(s) in the pod to ensure their proper running. A function of an instantiated node agent is to issue a pod admission request to a node. A pod admission request is prompted by a user or system component attempting to create, modify, or delete a pod. Before integrated scheduler 106 assigns the pod to the node, the pod request goes through admission controllers to validate and potentially modify the pod request prior to it being persisted in the cluster formed by nodes 104a-104n of cluster 100 of the container orchestration platform.

A conventional assignment of the pod to the first available space in cluster 100 is not always ideal. Kubernetes utilizes the Kubernetes Memory Manager, which provides information indicating the node's non-uniform memory access (NUMA) “affinity” to the pod. The information indicates the node's suitability for running the pod's container(s) based on memory availability. Execution performance in running the pod's container(s) on the node is not a prominent factor. For example, once a Kubelet requests a guaranteed QoS pod admission, a Kubernetes Topology Manager queries the Memory Manager about the preferred NUMA affinity for memory and hugepages for all containers in the pod. Memory bandwidth and latency, however, may not be considered. If memory bandwidth and latency are not considered, it may lead to suboptimal performance and inefficiencies. A pod whose applications impose memory-intensive workloads on a node, for example, may experience contention for memory resources, which is thus likely to adversely affect overall responsiveness in running the pod's container(s). Ignoring memory latency may impact the responsiveness and throughput of a container. Whenever a Kubelet starts a container as a part of the pod, the Kubelet passes the container's request with processor (e.g., CPU) and memory requirements to the container runtime, and the container is assigned based on memory location irrespective of the processor and memory performances of the assigned node in running the container.

The embodiments disclosed in the present disclosure overcome these limitations by providing scheduling techniques that assign an orchestration container (or Kubernetes pod) to the node of a cluster whose processor and memory capabilities are jointly discovered and determined to most likely optimize performance in running the container or pod. As used herein, “running” a container or pod means performing the processing and memory operations necessary for executing the one or more applications packaged in the container or pod. The scheduling techniques described in the present disclosure operate within a heterogeneous environment. A heterogeneous environment is one that may change over the lifetime of the containerized applications as new nodes are added to the cluster and/or old ones are deleted from the cluster.

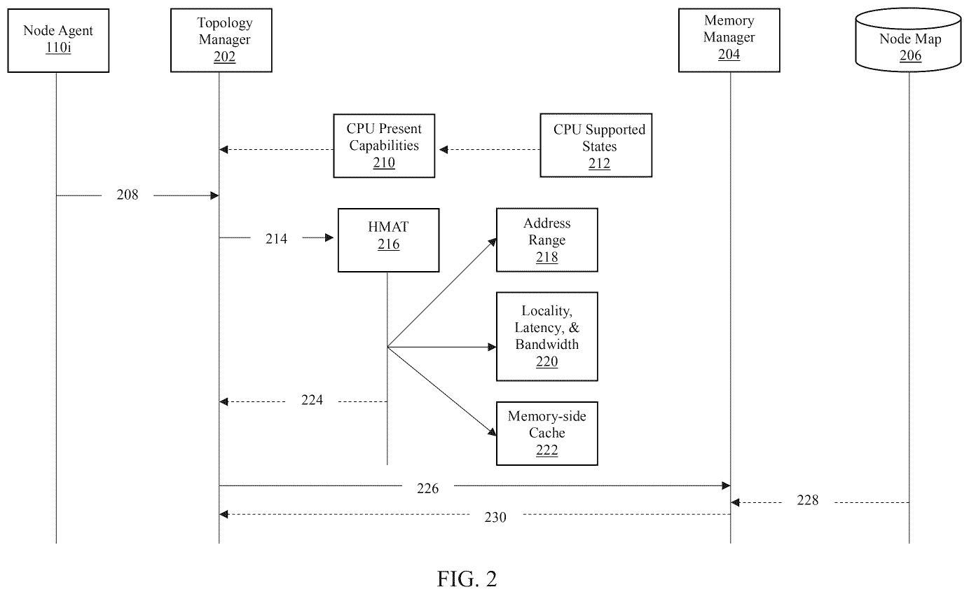

Referring additionally to FIG. 2, certain processes executed by example node agent 110i are illustrated. Node agent 110i is one of node agents 110a-110n and is instantiated on node 104i, which is one of nodes 104a-104n. In the Kubernetes context, node agent 110i is a Kubelet and is configured to interact with Topology Manager 202 and Memory Manager 204, including Node Map 206. Node agent 110i submits pod admission request 208 (e.g., guaranteed QoS). Topology Manager 202 responds by retrieving the present performance state information 210 and supported performance state information 212 of a processor in node 110i.

Additionally, Topology Manager 202 submits query 214 to Heterogeneous Memory Attributes Table (HMAT) 216. HMAT 226 is a custom-built, memory-performance table that is a unique feature of the present disclosure and that includes memory subsystem address range information structures 218, system locality, latency, and bandwidth information structures 220, and memory-side cache information structures 222. Memory subsystem address range information structures 218, system locality, latency, and bandwidth information structures 220, and memory-side cache information structures 222, are collectively memory attributes 224. Memory subsystem address range is the span of addresses that an information handling system's memory subsystem can access and manage, the range defined by a starting address and ending address within the memory of the information handling system. System locality refers to a node processor's tendency to repeatedly access the same memory locations within a brief time interval. Memory latency is a measure of the time interval between when a request is conveyed to a node's memory and when a response is received by the node's processor. Bandwidth is the rate that data can be read from or written to the memory of a node. The information structures are data whose structures for organizing and storing the data depend on the specific architecture of the information handling systems implementing the container orchestration platform.

Topology Manager 202 retrieves from IMAT 214 memory attributes 224. Topology Manager 202 submits query 226 to Memory Manager 204, which obtains free memory 228 from node map 206 and returns the information to the Topology Manager. Additionally, a Hint Provider (not shown) may convey to Topology Manager 204 one or more predefined Hints 230 based on the NUMA affinity of a container associated with pod admission request 208 (e.g., return “10” if a single node has adequate memory or “11” if a multi-NUMA node is needed).

Each node agent 110a-110n running on nodes 104a-104n, respectively, performs the same example procedures performed by node agent 110i described with reference to FIG. 2. The procedures generate performance capacity information that indicates each node's capability for running a pod, given the pod's specific requirements for running on a node of the cluster formed by nodes 104a-104n of container orchestration platform 100. Control plane 102 retrieves the performance capacity information via API server 108. The performance capacity information may be retrieved from node agents 110a-110n in response to creation of a pod having one or more containers.

Metrics generator 112 is configured to process the performance capacity information retrieved from node agents 110a-110n instantiated on nodes 104a-104n, respectively. Based on the performance capacity information, metrics generator 112 generates metrics for each of nodes 104a-104n, the metrics indicating the performance capacity of each node for running the one or more containers of the pod.

The metrics, in certain embodiments, may be based on performance capacity information that includes a memory or access latency associated with each of nodes 104a-104n. Given that latency is a measure of the time interval between when a request is conveyed to a node's memory and when a response is received by the node's processor, the latency is likely to affect each node's performance in running the container(s) of a pod.

In certain embodiments, metrics generator 112 is configured to generate metrics based on performance capacity information that includes memory bandwidth associated with each of nodes 104a-104n. Memory bandwidth—the rate that data can be read from or written to the memory of a node—is inversely related to, but distinct from, memory or access latency and is also likely to affect the node's performance in running the container(s) of a pod.

System locality, temporal and/or spatial, also may affect node performance in running the container(s) of a pod. In some embodiments, metric generator 112 is configured to generate metrics for nodes 104a-104n by processing performance capacity information that includes system locality with respect to nodes 104a-104n.

In certain embodiments, metrics generator 112 determines system locality, bandwidth and latency information pertaining to nodes 104a-104n by utilizing, at least in part, Advanced Configuration and Power Interface (ACPI) data. ACPI data is generated in accordance with the ACPI open standard that may be used by operating systems running on nodes 104a-104n and that may be used to discover and configure hardware components of the nodes.

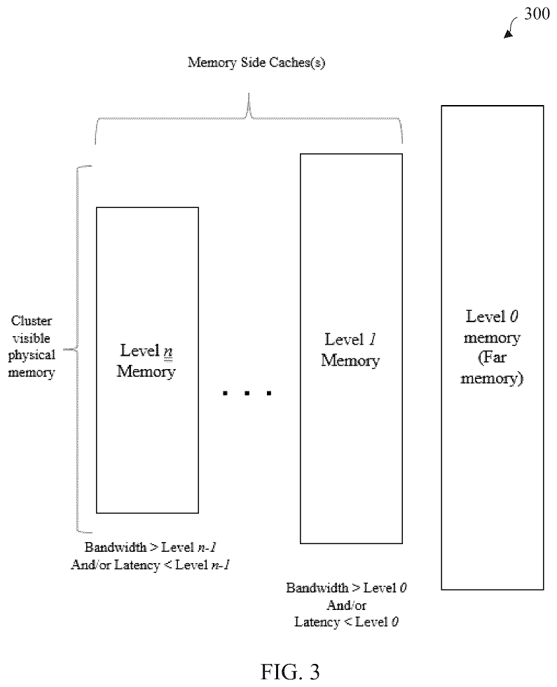

In certain embodiments, metrics generator 112 is configured to generate a metric, MemoryRange, which determines a range of memory locations of nodes 104a-104n. The metric is determined in accordance with the function of equation 1:

$$MemoryRange = g ( Arr ange ( ClusterNodes , ACPI ) , PerformanceTable ) \qquad EQ . 1$$

where g is itself partially a function of another function Arrange. Arrange is a function of two variables, ClusterNodes and ACPI. ClusterNodes is the set of all nodes 104a-104n in container orchestration platform 100, and ACPI is performance capacity information such as system locality, bandwidth, and latency associated with each of the nodes. FIG. 3 visually illustrates an ascending ordering 300 of node memory based on performance capacity information including system locality, bandwidth, and latency information. The function Arrange, based on ClusterNodes and ACPI generates the metric OrderedNodes, which is an ordering of the entire set of nodes 104a-104n in container orchestration platform 100.

The other argument of function g is PerformanceTable. PerformanceTable is the data retrieved from the custom-built, memory-performance table, IMAT 226 (FIG. 2). As illustrated in FIG. 2, Topology Manager 202 retrieves information from IMAT 226 in response to a message from node agent 110i (e.g., a Kubelet). Based on OrderedNodes and PerformanceTable, nodes 104a-104n are mapped to their corresponding memory location,
MemoryLocations (OrderedNodes, PerformanceTable)

where MemoryLocations is a function that maps the ordered nodes to their corresponding memory locations based on performance capacity information retrieved from the custom-built, memory-performance table, IMAT 226. The output of MemoryLocations is a range or set of memory locations, which according to performance criteria, are best suited for running the container(s) of the pod.

Integrated scheduler 106 is configured to integrate the memory-specific metrics with metrics based on performance capacity information pertaining to the processing capabilities of nodes 104a-104n. Given that a node may be a physical machine or virtual machine running on a physical machine, the node's processing capability corresponds to the capabilities of an information handling system's single- or multi-core CPU, GPU, or other type of processor depending on the specific type of the information handling system operating as a node or running a virtual machine.

Metrics generator 112 is configured to generate metrics based on the performance capacity information pertaining to the processing capabilities of nodes 104a-104n. Metrics generator 112 may be configured to generate metrics based on performance capacity information that includes the current states of nodes 104a-104n. A node's current state indicates the state of the node's processor at a given instant, such as executing instructions, standing idle, or in power-saving mode. Metrics generator 112 may be configured to generate metrics based on performance capacity information that includes the supported states of nodes 104a-104n. The supported states refer to a range of states that a node's processor can enter and are predefined by the processor architecture, which dictates the processor's performance capabilities and power-saving modes.

In certain embodiments, Topology Manager 202 retrieves processor performance capacity information from the Operating System Power Management (OSPM) component of the node's operating system. The OSPM may provide different power-operation modes and, if implemented with an ACPI, may switch a node between power state, performance state, and processor state. Performance capacity information retrieved by Topology Manager 202 from the OSPM component may include CPU Performance Capacity (_PPC) data, which is used to determine performance state (P-states) currently supported by a node's processor. The performance capacity information retrieved includes a Proportional Set Size (_PSS) entry number selected from a _PSS table that includes information such as the performance state's frequency, power consumption, and control values. The selected entry indicates the highest performance state that the OSPM component can enter at a given instant. The OSPM component chooses the corresponding state entry in the _PSS table.

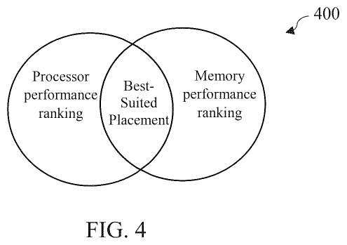

Prioritizing module 114 combines the metrics pertaining to processor performance and memory performance state of nodes 104a-104n. FIG. 4 illustrates combination 400, combining processor performance ranking and memory performance ranking. An optimum or best-suited node is one that ranks highly with respect to both processor performance and memory performance.

In certain embodiments, prioritization of nodes 104a-104n by prioritizing module 114 is based on a weighted average generated by metrics generator 112 averaging the separate aspects of the performance capacity information. For example, the weighted average of the performance capacity information may be a weighted average of at least two of a memory latency associated with each of nodes 104a-104n, a memory bandwidth associated with each of the nodes, a current state associated with a processor of each of the nodes, and the supported states associated with a processor of each of the nodes. In some embodiments, metrics generator 112 may be configured to generate the weighted average using weight coefficients whose values are determined based on user input.

Based on prioritizing module 114's prioritizing the metrics, node selector 116 selects the best-suited node among nodes 104a-104n. Node selector 116 selects the best-suited node among nodes 104a-104 by identifying the node whose metric measuring performance capacity (with respect to both processor and memory) in running the one or more containers is greater than metrics measuring performance capacities of the other nodes in running the one or more containers. Integrated scheduler 106 schedule the one or more containers to run on the best-suited node

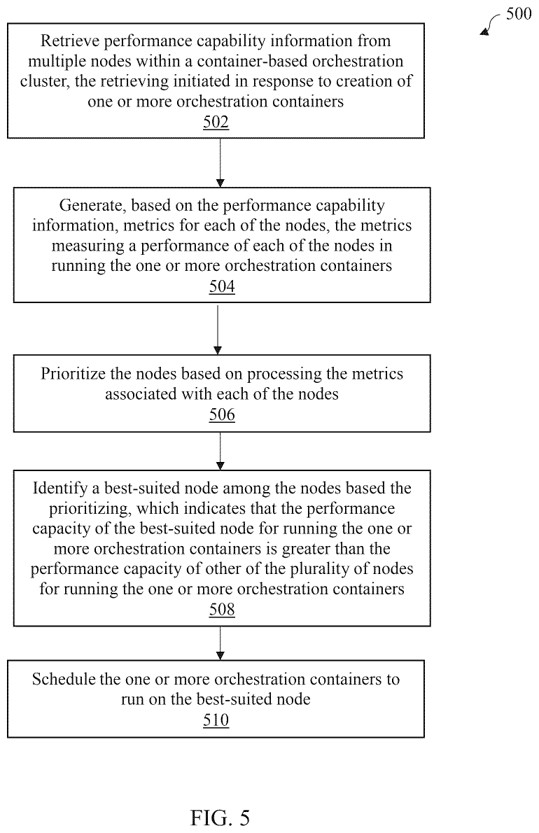

FIG. 5 is a flow diagram of method 500, a method for scheduling containers of an orchestration platform according to an embodiment of the present disclosure. Method 500 may be performed by an integrated scheduler such as integrated scheduler 106 described with reference to FIGS. 1-4. It will be readily appreciated that not every method step set forth in this flow diagram is always necessary, and that certain steps of the methods may be combined, performed simultaneously, in a different order, or perhaps omitted, without varying from the scope of the disclosure.

At block 502, performance capacity information is retrieved from nodes forming a cluster of container-based orchestration platform. In certain embodiments, the performance capacity information is retrieved via an API server when initiated in response to a user or information handling system creating one or more containers.

At block 504, based on the performance capacity information, metrics are generated for each of the plurality of nodes. The metrics may be generated by a metrics generator of an integrated scheduler. The metrics measure a performance capacity of each of the nodes for running the one or more containers

At block 506, the nodes are prioritized based on processing the metrics associated with each the nodes. Processing to prioritize the nodes based on the associated metrics can be performed by a prioritizing module of the integrated scheduler.

At block 508, based on the prioritizing, a best-suited node among the nodes is identified. The best-suited node is identified by a metric measuring the performance capacity of the identified node for running the created one or more containers. The metric associated with the best-suited node indicates a performance capacity of the identified node in running the one or more containers that exceed the performance capabilities of the other nodes for running the one or more containers. The integrated scheduler, at block 510, schedules the one or more containers of the pod to run on the best-suited node identified at block 508.

Method 500 may optionally include monitoring the performance of the best-suited node in running one or more containers. The monitoring may be performed by a feedback monitor and modifier of the integrated scheduler. If the feedback monitor and modifier detect a sub-optimal performance of the best-suited node in running the one or more containers, then an algorithm for selecting the best-suited node may be modified by the feedback monitor and modifier to better identify a node among the cluster of nodes for running the one or more containers.

In some embodiments, the metrics are based on performance capacity information include memory latency associated with each of the nodes. The metrics, in other embodiments, are additionally or alternatively based on performance capacity information that includes memory bandwidth associated with each of the nodes. In still other embodiments, the metrics are additionally or alternatively based on performance capacity information that includes supported states associated with a processor of each of the nodes. Additionally, or alternatively, is yet other embodiments, the metrics are based on performance capacity information that includes present states associated with a processor of each of the plurality of nodes.

The metrics in certain embodiments are generated as a weighted average of performance capacity information. The metrics, for example, may be a weighted average of at least two of a memory latency associated with each node, a memory bandwidth associated with each node, current states associated with a processor of each node, and/or the present states associated with a processor of each node. In certain embodiments, the weighted average is generated using weight coefficients that are determined in response to user input an information handling system used in creating the container orchestration platform.

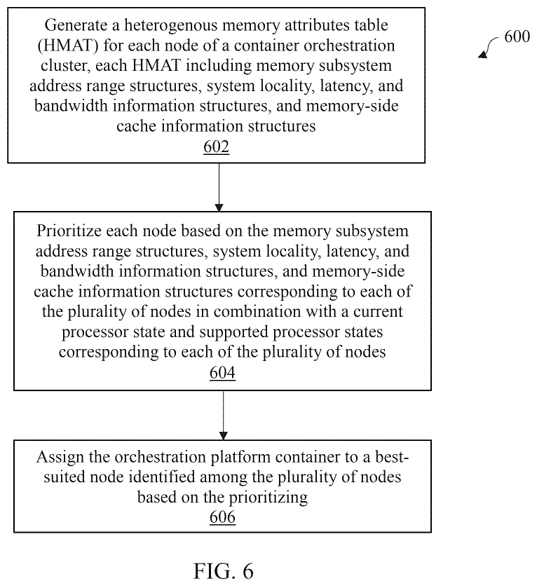

FIG. 6 is a flow diagram of method 600, a method for assigning an orchestration platform container to a node of a cluster on the orchestration platform according to an embodiment of the present disclosure. Method 600 may be performed by an integrated scheduler such as integrated scheduler 106 described with reference to FIG. 1 operating in conjunction with an HMAT such as HMAT 216 described with reference to FIG. 2. It will be readily appreciated that not every method step set forth in this flow diagram is always necessary, and that certain steps of the methods may be combined, performed simultaneously, in a different order, or perhaps omitted, without varying from the scope of the disclosure.

At block 602, the orchestration platform generates a heterogeneous memory attributes table (HMAT) for multiple nodes of the cluster. The HMAT includes memory subsystem address range structures, system locality, latency, and bandwidth information structures, and memory-side cache information structures for each of the nodes.

At block 604, each of the nodes the nodes is prioritized based on the memory subsystem address range structures, system locality, latency, and bandwidth information structures, and memory-side cache information structures corresponding to each of the plurality of nodes in combination with a current processor state and supported processor states corresponding to each of the plurality of nodes. At block 606, the orchestration platform container is assigned to a best-suited node, the best-suited node identified among the nodes of the cluster based on the prioritizing.

In certain embodiments, method 600 further includes monitoring the performance of the best-suited node in running the container. If a sub-optimal performance of the best-suited node in running the one or more containers is detected, then the algorithm for performing the prioritizing of the nodes may be modified to improve the performance.

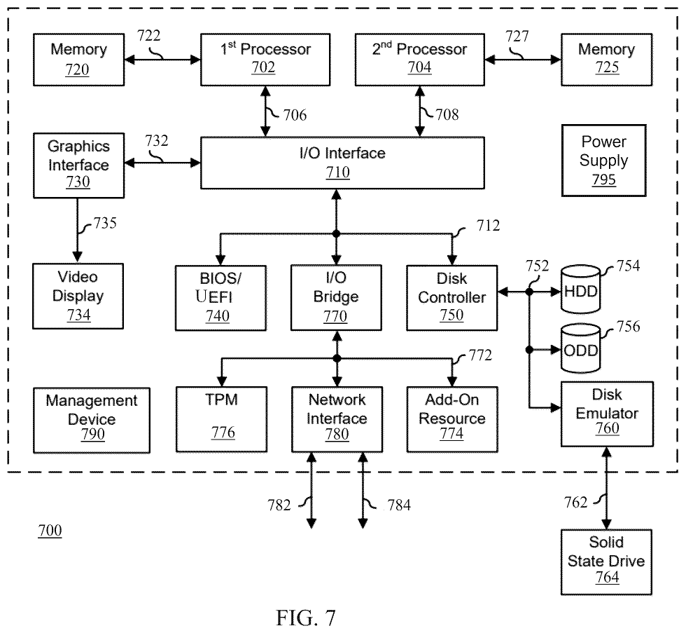

FIG. 7 shows a generalized embodiment of an information handling system 700 according to an embodiment of the present disclosure. Information handling system 700 may be substantially similar to the information handling systems that serve as nodes or that run one or more virtual machines forming a cluster of a container-based orchestration platform such as cluster 100 illustrated in FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 700 can include processing resources for executing machine-executable code, such as a central processing unit (CPU), a programmable logic array (PLA), an embedded device such as a System-on-a-Chip (SoC), or other control logic hardware. Information handling system 700 can also include one or more computer-readable mediums for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 700 can also include one or more buses operable to transmit information between the various hardware components.

Information handling system 700 can include devices or modules that embody one or more of the devices or modules described below and operates to perform one or more of the methods described below. Information handling system 700 includes a processors 702 and 704, an input/output (I/O) interface 710, memories 720 and 725, a graphics interface 730, a basic input and output system/universal extensible firmware interface (BIOS/UEFI) module 740, a disk controller 750, a hard disk drive (HDD) 754, an optical disk drive (ODD) 756, a disk emulator 760 connected to an external solid state drive (SSD) 764, an I/O bridge 770, one or more add-on resources 774, a trusted platform module (TPM) 776, a network interface 780, a management device 790, and a power supply 795. Processors 702 and 704, I/O interface 710, memory 720, graphics interface 730, BIOS/UEFI module 740, disk controller 750, HDD 754, ODD 756, disk emulator 760, SSD 764, I/O bridge 770, add-on resources 774, TPM 776, and network interface 780 operate together to provide a host environment of information handling system 700 that operates to provide the data processing functionality of the information handling system. The host environment operates to execute machine-executable code, including platform BIOS/UEFI code, device firmware, operating system code, applications, programs, and the like, to perform the data processing tasks associated with information handling system 700.

In the host environment, processor 702 is connected to I/O interface 710 via processor interface 706, and processor 704 is connected to the I/O interface via processor interface 708. Memory 720 is connected to processor 702 via a memory interface 722. Memory 725 is connected to processor 704 via a memory interface 727. Graphics interface 730 is connected to I/O interface 710 via a graphics interface 732 and provides a video display output 736 to a video display 734. In a particular embodiment, information handling system 700 includes separate memories that are dedicated to each of processors 702 and 704 via separate memory interfaces. An example of memories 720 and 730 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 740, disk controller 750, and I/O bridge 770 are connected to I/O interface 710 via an I/O channel 712. An example of I/O channel 712 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 710 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 740 includes BIOS/UEFI code operable to detect resources within information handling system 700, to provide drivers for the resources, initialize the resources, and access the resources. BIOS/UEFI module 740 includes code that operates to detect resources within information handling system 700, to provide drivers for the resources, to initialize the resources, and to access the resources.

Disk controller 750 includes a disk interface 752 that connects the disk controller to HDD 754, to ODD 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an IEEE 4394 (Firewire) interface, a proprietary interface, or a combination thereof. Alternatively, solid-state drive 764 can be disposed within information handling system 700.

I/O bridge 770 includes a peripheral interface 772 that connects the I/O bridge to add-on resource 774, to TPM 776, and to network interface 780. Peripheral interface 772 can be the same type of interface as I/O channel 712 or can be a different type of interface. As such, I/O bridge 770 extends the capacity of I/O channel 712 when peripheral interface 772 and the I/O channel are of the same type, and the I/O bridge translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as I/O interface 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be connected to external network resources (not illustrated). The network resource can include another information handling system, a data storage system, another network, a grid management system, another suitable resource, or a combination thereof.

Management device 790 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 700. In particular, management device 790 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 700, such as system cooling fans and power supplies. Management device 790 can include a network connection to an external management system, and the management device can communicate with the management system to report status information for information handling system 700, to receive BIOS/UEFI or system firmware updates, or to perform other task for managing and controlling the operation of information handling system 700.

Management device 790 can operate off a separate power plane from the components of the host environment so that the management device receives power to manage information handling system 700 when the information handling system is otherwise shut down. An example of management device 790 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 790 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. An integrated scheduler of a container-based orchestration platform, the integrated scheduler comprising:
a metrics generator configured to generate metrics for each of a plurality of nodes of a cluster implemented on the container-based orchestration platform, wherein the metrics are based on performance capacity information and measure a performance capacity of each of the plurality of nodes for running one or more orchestration platform containers
a prioritizing module communicatively coupled with the metrics generator, wherein the prioritizing module is configured to prioritize the plurality of nodes based on processing the metrics generated for the plurality of nodes; and
a node selector communicatively coupled with the prioritizing module, wherein the node selector is configured to identify a best-suited node among the plurality of nodes, and wherein the node selector identifies the best-suited node based on priorities generated by the prioritizing module that indicate a performance capacity of the best-suited node in running the one or more orchestration containers that is greater than the performance capacity of other of the plurality of nodes in running the one or more orchestration containers,
wherein the integrated scheduler is configured to schedule the one or more orchestration containers to run on the best-suited node.

2. The integrated scheduler of claim 1, further comprising:
a feedback monitor and modifier operatively coupled with the prioritizing module;
wherein the feedback monitor and modifier is configured to monitor a performance of the best-suited node in running the one or more orchestration containers; and
wherein the feedback monitor and modifier is further configured to modify an algorithm executed by the prioritizing module for performing the prioritization in response to detecting a sub-optimal performance of the best-suited node in running the one or more orchestration containers.

3. The integrated scheduler of claim 1, wherein the metrics are based on performance capacity information including memory latency associated with each of the plurality of nodes.

4. The integrated scheduler of claim 1, wherein the metrics are based on performance capacity information including memory bandwidth associated with each of the plurality of nodes.

5. The integrated scheduler of claim 1, wherein the metrics are based on performance capacity information including supported states associated with a processor of each of the plurality of nodes.

6. The integrated scheduler of claim 1, wherein the metrics are based on performance capacity information including present states associated with a processor of each of the plurality of nodes.

7. The integrated scheduler of claim 1, wherein the metrics generator is configured to generate metrics for each of the plurality of nodes based on a weighted average of the performance capacity information.

8. The integrated scheduler claim 7, wherein the metrics generator is configured to generate the weighted average of the performance capacity information as a weighted average of at least two of a memory latency associated with each of the plurality of nodes, a memory bandwidth associated with each of the plurality of nodes, a current state associated with a processor of each of the plurality of nodes, and supported states associated with a processor of each of the plurality of nodes.

9. The integrated scheduler of claim 7, wherein the metrics generator is configured to generate the weighted average using weight coefficients determined based on a user input.

10. A computer-implemented method of performance-based container orchestration scheduling, the method comprising:
retrieving, via a control plane API server, performance capacity information from a plurality of nodes within a container-based orchestration cluster, wherein the retrieving is initiated in response to creation of one or more containers;
generating, by a metrics generator, based on the performance capacity information, metrics for each of the plurality of nodes, where the metrics measures a performance capacity of each of the plurality of nodes in running the one or more containers
prioritizing, by a prioritizing module, the plurality of nodes based on processing the metric for each of the plurality of nodes;
identifying, by a node selector, based on the prioritizing, a best-suited node among the plurality of nodes, wherein the performance capacity of the best node in running the one or more containers is greater than the performance capacity of other of the plurality of nodes in running the one or more containers; and
scheduling, by an integrated scheduler, the one or more containers to run on the best-suited node.

11. The computer-implemented method claim 10, further comprising:
monitoring a performance of the best-suited node in running the one or more containers; and
modifying an algorithm for performing the prioritizing in response to detecting a sub-optimal performance of the best-suited node in running the one or more containers.

12. The computer-implemented method of claim 10, wherein the metrics are based on performance capacity information including memory latency associated with each of the plurality of nodes.

13. The computer-implemented method of claim 10, wherein the metrics are based on performance capacity information including memory bandwidth associated with each of the plurality of nodes.

14. The computer-implemented method of claim 10, wherein the metrics are based on performance capacity information including supported states associated with a processor of each of the plurality of nodes.

15. The computer-implemented method of claim 10, wherein the metrics are based on performance capacity information including present states associated with a processor of each of the plurality of nodes.

16. The computer-implemented method of claim 10, wherein the generating of the metrics for each of the plurality of nodes comprises generating a weighted average of performance capacity information.

17. The computer-implemented method claim 16, wherein the weighted average of performance capacity information is a weighted average of at least two of a memory latency of memories associated with each of the plurality of nodes, a memory bandwidth of memories associated with each of the plurality of nodes, current states associated with a processor of each of the plurality of nodes, and present states associated with a processor of each of the plurality of nodes.

18. The computer-implemented method of claim 16, wherein the weighted average is generated using weight coefficients determined in response to user input.

19. A computer-implemented method of assigning an orchestration platform container to a node of a cluster, the method comprising:
generating a heterogeneous memory attributes table (HMAT) for a plurality of nodes of the cluster, wherein the HMAT includes memory subsystem address range structures, system locality, latency, and bandwidth information structures, and memory-side cache information structures for each of the plurality of node;
prioritizing, by a prioritizing module, each of the plurality of nodes based on the memory subsystem address range structures, system locality, latency, and bandwidth information structures, and memory-side cache information structures corresponding to each of the plurality of nodes in combination with a current processor state and supported processor states corresponding to each of the plurality of nodes; and
assigning, by a control plane scheduler, the orchestration platform container to a best-suited node identified among the plurality of nodes based on the prioritizing.

20. The computer-implemented method of claim 19, further comprising:
monitoring a performance of the best-suited node in running the orchestration platform container; and
modifying an algorithm for performing the prioritizing in response to detecting a sub-optimal performance of the best-suited node in running the orchestration platform container.
